(19) United States
(12) Patent Application Publication
(10) Pub. No.: US 2024/0025048 A1
(43) Pub. Date: Jan. 25, 2024

(54) PARKING ROBOT FOR VEHICLE

(71) Applicant: HL MANDO CORPORATION, Pyeonglaek-si (KR)

(72) Inventors: Seong Ho CHOI, Anyang-si (KR); Joon Kyu SONG, Seongnam-si (KR); Jeong Jae PARK, Seoul (KR)

(73) Assignee: HL MANDO CORPORATION, Pyeongtaek-si (KR)

(21) Appl. No.: 18/375,254

(22) Filed: Sep. 29, 2023

Related U.S. Application Data
(63) Continuation of application No. PCT/KR2022/004798, filed on Apr. 4, 2022.

(30) Foreign Application Priority Data
Apr. 2, 2021 (KR) 10-2021-0043428

(51) Int. Cl. B25J 9/16; B60P 3/07; B25J 9/00

(52) U.S. Cl. CPC B25J 9/1676; B60P 3/07; B25J 9/1697; B25J 9/0075

(57) ABSTRACT

A robot for parking a vehicle is provided. The robot for parking a vehicle according to an aspect of the present disclosure, which lifts a vehicle having a pair of first wheels and a pair of second wheels to park in a parking lot, may include a first module for lifting the pair of first wheels by moving to the side of a first direction as a direction in which the rotation shafts of the pair of first wheels of the vehicle extend; a second module which is disposed on the side of a second direction as a direction from the pair of first wheels of the first module toward the pair of second wheels and lifts the pair of second wheels by moving toward the side of the first direction of the pair of second wheels of the vehicle; a connection link for connecting the first module and the second module; and a controller for controlling the first module and the second module.

### CROSS-REFERENCE TO RELATED APPLICATION

This application claims priority to and the benefit of Korean Patent Application No. 10-2021-0043428, filed on Apr. 2, 2021, the disclosure of which is incorporated herein by reference in its entirety.

### TECHNICAL FIELD

The present disclosure relates to a robot for parking a vehicle, and more specifically to a robot for parking a vehicle, which is capable of parking a vehicle at a specific location in a parking lot by lifting the vehicle.

### BACKGROUND ART

A vehicle is a transportation means commonly used in modern society, and the amount of usage of the vehicle is continuously increasing. This increase in the amount of usage of the vehicle causes a problem of the lack of parking spaces for storing the vehicle when the vehicle is not used.

Accordingly, parking spaces are narrowed in order to more efficiently park the vehicle in a large city with a high population density.

Even when the parking spaces are designed to be narrow, since a minimum space for parking or exiting the vehicle is required when the driver operates, there is a limitation in designing the parking space to be small.

Furthermore, when the parking space is narrowed, a high skill level is inevitably required in the process of directly parking the vehicle by the driver, and as a result, large and small accidents occur in the process of parking by the inexperienced driver.

Recently, a mechanical parking facility capable of securing a parking space and providing dense parking regardless of the driver's skill level is being developed.

However, since the conventional mechanical parking facility needs to move the vehicle to a moving space of the mechanical parking facility directly by the driver, the driving skill level of the driver is still inevitably required.

In addition, since the size of the vehicle capable of parking is limited, the mechanical parking facility cannot solve the fundamental problem of securing the parking space.

Accordingly, there is a growing demand for parking assist equipment that can utilize the conventionally used parking space as densely as possible, has high compatibility with the size of the vehicle, and does not require the driver's skill in parking.

### DISCLOSURE

### Technical Problem

The present disclosure has been devised to solve the problems described above, and an object of the present disclosure is to provide a robot for parking a vehicle that can lift a vehicle to park the vehicle in a specific parking area without the driver's driving.

In addition, another object of the present disclosure is to provide a robot for parking a vehicle that can use various terrains of a parking lot by using a vehicle suspension.

The problems of the present disclosure are not limited to the problems mentioned above, and other problems that are not mentioned will be clearly understood by those of ordinary skill in the art to which the present disclosure pertains from the following description.

### Technical Solution

In order to solve the above problems, the robot for parking a vehicle according to an aspect of the present disclosure, which lifts a vehicle having a pair of first wheels and a pair of second wheels to park in a parking lot, may include a first module for lifting the pair of first wheels by moving to the side of a first direction as a direction in which the rotation shafts of the pair of first wheels of the vehicle extend; a second module which is disposed on the side of a second direction as a direction from the pair of first wheels of the first module toward the pair of second wheels and lifts the pair of second wheels by moving toward the side of the first direction of the pair of second wheels of the vehicle; a connection link for connecting the first module and the second module; and a controller for controlling the first module and the second module.

In this case, the connection link may be formed such that the first module is pivotally rotatable about a rotational axis extending in the first direction relative to the second module.

In this case, the connection link may be formed such that the first module is reciprocally movable in a third direction perpendicular to the first direction and the second direction relative to the second module.

In this case, the first module may include a first body extending in the second direction; and a first front fork and a first rear fork coupled to the first body and supporting the pair of first wheels, and the second module may include a second body extending in the second direction; and a second front fork and a second rear fork coupled to the second body and supporting the pair of second wheels.

In this case, the first body may include a first rail extending in the second direction, wherein the first front fork may include a first front fork body coupled to the first rail so as to be reciprocally movable in the second direction, and a first front fork bar extending from the first front fork body in the first direction and supporting one side of the pair of first wheels, and wherein the first rear fork may include a first rear fork body coupled to the first rail so as to be reciprocally movable in the second direction, and a first rear fork bar extending from the first rear fork body in the first direction and supporting the other side of the pair of first wheels.

In this case, the first front fork may further include a first front powered wheel disposed on a side opposite to a third direction perpendicular to the first direction and the second direction of the first front fork body to provide a driving force; and a first rear powered wheel disposed on a side opposite to the third direction of the first rear fork body to provide a driving force.

In this case, the first front fork may further include at least one first front auxiliary wheel disposed on a side opposite to the third direction of the first front fork bar; and at least one first rear auxiliary wheel disposed on a side opposite to the third direction of the first rear fork bar.

In this case, the first front fork may further include a first front support member disposed on one side of the first front fork bar toward the first rear fork bar, and the first rear fork may further include a first rear support member disposed on one side of the first rear fork bar toward the first front fork bar.

In this case, the controller may place the pair of first wheels between the first front support member and the first rear support member such that the pair of first wheels are spaced apart from a ground of the parking lot, and move the first front support member and the first rear support member to be adjacent to each other.

In this case, the robot for parking a vehicle may further include a first object recognition sensor disposed on a side opposite to the second direction of the first body to recognize an object in three dimensions within a predetermined area; and a second object recognition sensor disposed on a side of the second direction of the second body to recognize an object in three dimensions within a predetermined area, wherein the controller may analyze information collected by the first object recognition sensor and the second object recognition sensor to drive the first module and the second module.

In this case, the robot for parking a vehicle may further include a first object recognition auxiliary sensor disposed on a side opposite to the second direction of the first body to recognize an object in two dimensions within a predetermined area perpendicular to a third direction perpendicular to the first direction and the second direction; and a second object recognition auxiliary sensor disposed at an end of the second direction in the second rear fork to recognize an object in two dimensions within a predetermined area perpendicular to the third direction, wherein the controller further analyzes information collected by the first object recognition auxiliary sensor and the second object recognition auxiliary sensor to drive the first module and the second module.

In this case, the robot for parking a vehicle may further include a marker sensor disposed between the first body and the second body to recognize a marker, wherein the controller may compare location information collected by the first object recognition sensor and the second object recognition sensor with location information of a marker recognized by the marker sensor to correct location information collected by the first object recognition sensor and the second object recognition sensor.

In this case, the robot for parking a vehicle may further include a first ground height recognition sensor disposed at an end of the second direction of the first rear fork to recognize an object in two dimensions within a predetermined area perpendicular to the second direction, wherein when the distance between the lower surface of the vehicle and the ground of the parking lot through the first ground height recognition sensor is greater than the distance from the upper surface of the first rear fork to the ground of the parking lot, the controller may move the first module and the second module in the first direction such that the first front fork and the first rear fork support the first wheel and the second front fork and the second rear fork support the second wheel.

In this case, the first module may further include a first distance recognition sensor disposed on the side of the first direction to measure a distance between the vehicle and the first module, and wherein the controller may move the first module and the second module in the first direction until the distance measured by the first distance recognition sensor becomes a predetermined distance.

In this case, the robot for parking a vehicle may further include a wheel recognition sensor disposed between the first module and the second module to recognize the first wheel and the second wheel of the vehicle, wherein the controller may the first module and the second module such that a midpoint between the first module and the second module is arranged side by side with a midpoint be the first wheel and the second wheel along the first direction.

### Advantageous Effects

By including a first module for lifting a first wheel and a second module for lifting a second wheel, the robot for a parking vehicle according to an exemplary embodiment of the present disclosure is capable of lifting a vehicle to park the vehicle in a specific parking area without the driver's driving.

In addition, the robot for parking a vehicle according to an exemplary embodiment of the present disclosure is capable of using various terrains of a parking lot by using the vehicle's suspension by connecting the separated first module and the second module with a connection link.

The effects of the present disclosure are not limited to the above effects, but it should be understood to include all effects that can be inferred from the configuration of the invention described in the description or claims of the present disclosure.

### DESCRIPTION OF DRAWINGS

FIG. 1 is a perspective view of the robot for parking a vehicle according to an exemplary embodiment of the present disclosure viewed in one direction.

FIG. 2 is a perspective view of the robot for parking a vehicle according to an exemplary embodiment of the present disclosure viewed in another direction.

FIG. 3 is an enlarged view illustrating a connection link of the robot for parking a vehicle according to an exemplary embodiment of the present disclosure.

FIG. 4 is a block diagram illustrating the connection relationship of a controller of the robot for parking a vehicle according to an exemplary embodiment of the present disclosure.

FIG. 5 is a view of the detection areas of a first object recognition sensor and a second object recognition sensor of the robot for parking a vehicle according to an exemplary embodiment of the present disclosure viewed in a direction opposite to the third direction.

FIG. 6 is a view of the detection areas of a first object recognition auxiliary sensor and a second object recognition auxiliary sensor of the robot for parking a vehicle according to an exemplary embodiment of the present disclosure viewed in a direction opposite to the first direction.

FIG. 7 is a view of the detection area of a first ground height recognition sensor of the robot for parking a vehicle according to an exemplary embodiment of the present disclosure viewed in a direction opposite to the second direction.

FIG. 8 is a view of the detection area of a first ground height recognition sensor of the robot for parking a vehicle according to an exemplary embodiment of the present disclosure viewed in a direction opposite to the first direction.

FIG. 9 is a view of the sensing area of a first distance recognition sensor of the robot for parking a vehicle according to an exemplary embodiment of the present disclosure viewed in a direction opposite to the second direction.

FIG. 10 is a view of the detection area of a wheel recognition sensor the robot for parking a vehicle according to an exemplary embodiment of the present disclosure viewed in a direction opposite to the third direction.

FIG. 11 is a diagram illustrating a process in which the robot for parking a vehicle according to an exemplary embodiment of the present disclosure recognizes a marker and moves.

### MODES OF THE INVENTION

Hereinafter, with reference to the accompanying drawings, the exemplary embodiments of the present disclosure will be described in detail so that those of ordinary skill in the art to which the present disclosure pertains can easily practice the present disclosure. The present disclosure may be embodied in many different forms and is not limited to the exemplary embodiments described herein. In order to clearly describe the present disclosure, parts irrelevant to the description are omitted from the drawings, and the same reference numerals are assigned to the same or similar components throughout the specification.

The words and terms used in the present specification and claims are not limited and interpreted to the conventional or dictionary meanings, and in accordance with the principle that the inventors may define terms and concepts in order to describe their invention in the best way, these should be interpreted as meanings and concepts consistent with the technical spirit of the present disclosure.

Therefore, since the exemplary embodiment described in the present specification and the configuration illustrated in the drawings correspond to a preferred exemplary embodiment of the present disclosure and do not represent all of the technical spirit of the present disclosure, the corresponding configuration may have various equivalents and modifications to replace the same at the time of filing of the present disclosure.

In the present specification, terms such as “include” or “have” are intended to describe the presence of features, numbers, steps, operations, components, parts or a combination thereof described in the specification, but it is to be understood that it does not preclude the possibility of the presence or addition of one or more other features, numbers, steps, operations, components, parts or a combination thereof.

That a component is at the “front”, “rear”, “above” or “below” of another component not only includes cases where, unless otherwise specified, it is in direct contact with another component and is disposed at the “front”, “rear”, “above” or “below”, but also cases where other components are placed in the middle. In addition, that a component is “connected” with another component includes cases where, unless otherwise specified, it is in direct contact with each other, but also cases where it is indirectly connected to each other.

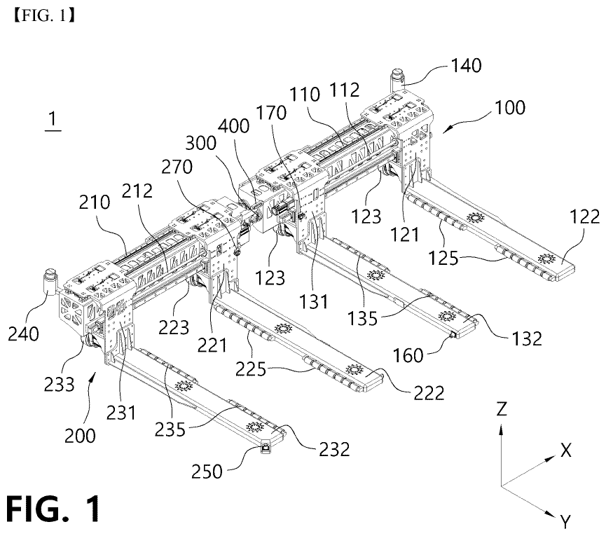

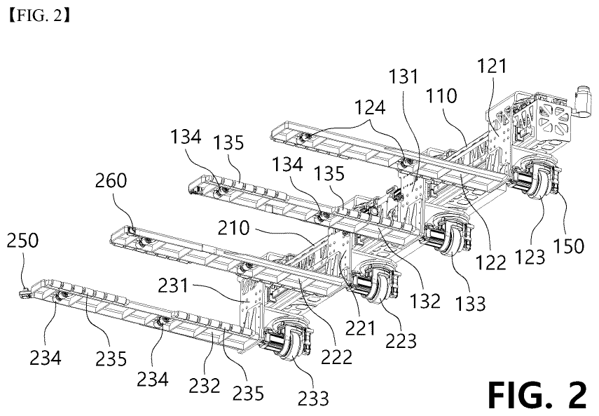

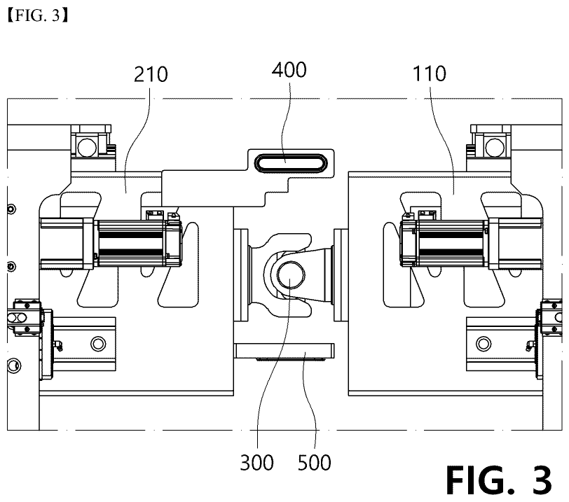

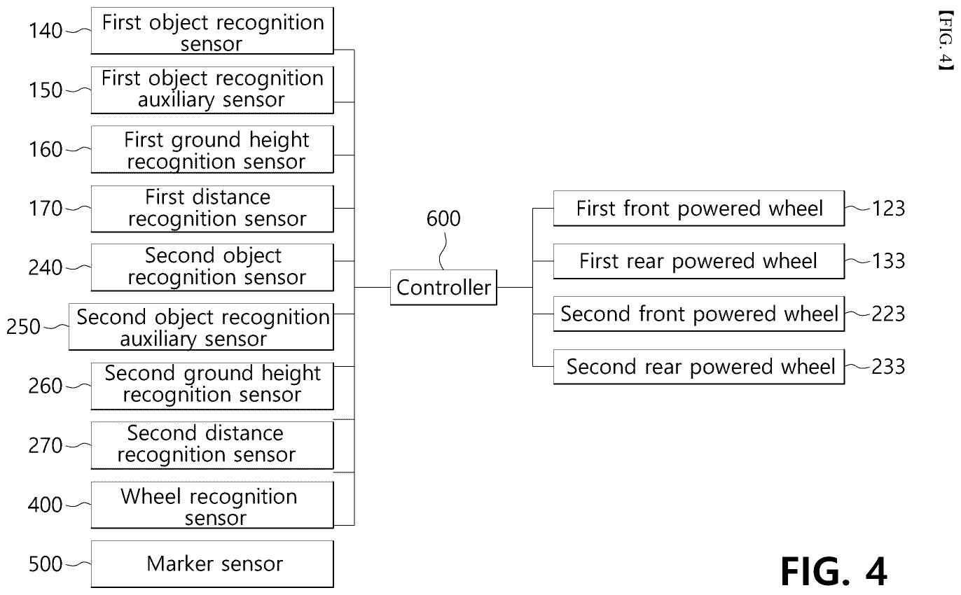

FIG. 1 is a perspective view of the robot for parking a vehicle according to an exemplary embodiment of the present disclosure viewed in one direction. FIG. 2 is a perspective view of the robot for parking a vehicle according to an exemplary embodiment of the present disclosure viewed in another direction. FIG. 3 is an enlarged view illustrating a connection link of the robot for parking a vehicle according to an exemplary embodiment of the present disclosure. FIG. 4 is a block diagram illustrating the connection relationship of a controller of the robot for parking a vehicle according to an exemplary embodiment of the present disclosure. Hereinafter, the robot 1 for parking a vehicle according to an exemplary embodiment of the present disclosure will be described with reference to the drawings.

In this case, the direction in which the X-axis of FIG. 1 faces is defined forward as the opposite direction to a second direction, the direction in which the Y-axis faces is defined right as a first direction, and the direction in which the Z-axis faces is defined upward as a third direction. In order to clearly express the features of the configuration in the drawings, the thickness or size is exaggerated, and the thickness or size of the configuration shown in the drawings is not shown as in reality.

As illustrated in FIG. 1, the robot for parking a vehicle according to an exemplary embodiment of the present disclosure lifts up a vehicle 10 having a pair of first wheels 20 and a pair of second wheels 30 to park in a parking lot. To this end, the robot for parking a vehicle according to an exemplary embodiment of the present disclosure includes a first module 100, a second module 200, a connection link 300 and a controller 600.

In this case, if the vehicle 10 is provided with a pair of first wheels 20 at the front and a pair of second wheels 30 at the rear, the shape or type of the vehicle is not limited.

As illustrated in FIG. 1, the first module 100 moves to the side of the first direction in a direction in which the rotation shafts of the pair of first wheels 20 of the vehicle 10 extend so as to lift the pair of first wheels 20.

As illustrated in FIG. 1, the second module 200 is disposed in the second direction, that is, at the rear of the first module 100. The second module 200 may move to the side of a direction opposite to the first direction of the pair of second wheels 30 of the vehicle 10 so as to lift the pair of second wheels 30.

In this case, the second module 200 is different from the first module 100 in the position where the body is disposed and the position of the sensor provided, and the first module 100 and the second module 200 are formed with the same configuration. Accordingly, in the below, each configuration of the second module 200 is replaced with the description of each configuration of the first module 100. In this case, the difference that distinguishes the configurations of the first module 100 and the second module 200 is classified into “first” and “second”, and unless otherwise specified, if the terms excluding “first” and “second” are the same, the function or shape is also considered to be the same.

As illustrated in FIG. 1, the connection link 300 connects the first module 100 and the second module 200 such that the first module 100 and the second module 200 are not separated.

In this case, as illustrated in FIG. 3, the connection link 300 may be formed to be pivotally rotatable about a rotation axis in which the first module 100 and the second module 200 relatively extend in the first direction. That is, when the robot 1 for parking a vehicle crosses an obstacle, when the first module 100 first passes over the obstacle, the front of the first module 100 moves relatively upward such that the first body 110 is tilted.

In this case, since the first module 100 supports the first wheel 20, the suspension on the side of the first wheel 20 of the vehicle 10 is compressed to the extent that the front end of the first module 100 moves upward. That is, the robot 1 for parking a vehicle may indirectly use the suspension of the vehicle 10 by pivot rotation of the connection link 300 without a separate suspension.

In particular, the inclination of the first body 110 may be freely changed even when the first wheel 20 is fixed while a first front support member 125 and a first rear support member 135, which will be described below, rotate in this process.

Meanwhile, although not illustrated in the drawings, the connection link 300 may be formed such that the first module 100 may be reciprocally moveable in the third direction relative to the second module 200. Through this, the suspension of the vehicle 10 may be used more freely. In addition, by reducing rotation of the first front support member 125 and the first rear support member 135, it is possible to more stably support the first wheel 20.

Although not illustrated in the drawings, the controller 600 may be disposed inside the first body 110 of the first module 100 or the second body 210 of the second module 200. The controller 600 is connected to a first object recognition sensor 140, a first object recognition auxiliary sensor 150, a first ground height recognition sensor 160, a first distance recognition sensor 170, a second object recognition sensor 240, a second object recognition auxiliary sensor 250, a second ground height recognition sensor 260, a second distance recognition sensor 270, a wheel recognition sensor 400 and a marker sensor 500 which are described below, and collects information from the above-described sensors to control the first module 100 and the second module 200.

In this case, as illustrated in FIGS. 1 and 2, the first module 100 of the robot 1 for parking a vehicle according to an exemplary embodiment of the present disclosure includes a first body 110, a first front fork 120, a first rear fork 130, a first object recognition sensor 140, a first object recognition auxiliary sensor 150, a first ground height recognition sensor 160 and a first distance recognition sensor 170.

As illustrated in FIG. 1, the first body 110 extends rearward in the second direction. In this case, the first body 110 is provided with a first rail 112 extending rearward.

The first body 110 is not limited in shape as long as the first rail 112 may be provided. For example, it may be formed in a rectangular parallelepiped frame structure.

The first rail 112 may be formed on the right side or the upper side of the first body 110. Furthermore, a plurality of first rails 112 may be formed on the right side and upper side of the first body 110. In the present exemplary embodiment, a plurality of first rails are formed on the right side and the upper side.

A first front fork 120 is coupled to the first body 110. The first front fork 120 is disposed in front of the pair of first wheels 20 to support one side of the pair of first wheels 20.

In this case, as terms included in the names of the configuration mentioned in the present specification, the front or rear is only a term for distinguishing the configuration, such as one side or the other side of the wheel, and is not a term for limiting the direction.

To this end, as illustrated in FIGS. 1 and 2, the first front fork 120 of the robot 1 for parking a vehicle according to an exemplary embodiment of the present disclosure includes a first front fork body 121 and a first front fork bar 122, a first front powered wheel 123, a first front auxiliary wheel 124 and a first front support member 125.

The first front fork body 121 is coupled to the first rail 112 to be reciprocally movable in the second direction. The first front fork body 121 may be formed in a 1 shape so as to cover the right side and the upper side of the first body 110. Accordingly, the first front fork body 121 may be firmly coupled to the first rail 112 formed on the right side and the upper side.

If the first front fork body 121 may be moved while being guided by the first rail 112 without departing from the first rail 112, the first rail 112 and the first front fork body 121 are not limited in the method of coupling.

The movement of the first front fork body 121 along the first rail 112 is controlled by a controller 600 to be described below. In this case, the driving force to be guided and moved along the first rail 112 of the first front fork body 121 may be provided by a separate motor or may be provided by a first front powered wheel 123 to be described below. This will be described below.

As illustrated in FIG. 1, the first front fork bar 122 extends in the first direction from the first front fork body 121 and supports one side of the pair of first wheels 20.

In this case, the first front fork bar 122 is formed to have a thickness in the vertical direction, which is thinner than the ground height defined by an interval between the lower surface of the vehicle 10 and the ground of a parking lot by the first wheel 20 of the vehicle 10.

An extended length of the first front fork bar 122 may vary depending on the design. For example, it may be formed to be larger than the maximum left and right width of the vehicle 10 that may be parked according to the environment of the parking lot. Accordingly, the first front fork bar 122 may support all of the pair of first wheels of the vehicle 10.

The first front fork bar 122 is disposed in front of the pair of first wheels 20 so as be inserted between the lower surface of the vehicle 10 and the ground of the parking lot such that the first module 100 moves in the first direction.

In this case, the first front fork bar 122 protrudes from the lower side of the right side surface of the first front fork body 121 such that it may be inserted under the lower surface of the vehicle 10.

While the first front fork bar 122 is disposed in front of the first wheel 20 of the vehicle 10, it comes into contact with the front of the first wheel 20 as the first front fork body 121 moves rearward. In this case, the first rear fork bar 132 to be described below also moves forward together.

As for the first front fork bar 122 and the first rear fork bar 132, while the front of the first wheel 20 is supported by the first front fork bar 122 and the rear thereof is supported by the first rear fork bar 132, the first module 100 lifts the first wheel 20 of the vehicle 10 by moving until the first wheel 20 is separated from the ground of the parking lot.

As illustrated in FIG. 2, the first front powered wheel 123 is disposed in a direction opposite to a third direction perpendicular to the first direction and the second direction of the first front fork body 121, that is, on the lower surface of the first front fork body 121.

The first front powered wheel 123 provides an independent rotational driving force. Accordingly, the first module 100 may move on the ground of the parking lot by the first front powered wheel 123 controlled by the controller 600.

The first front powered wheel 123 is capable of rotating 360 degrees with the third direction as the direction of a rotation axis so as to control the moving direction of the first module 100 from the current position while the rotation shaft of the wheel is arranged parallel to the ground of the parking lot. Accordingly, the first module 100 may change the moving direction without turning.

In addition, the first front powered wheel 123 is fixed to the first front fork body 121 such that the first front fork body 121 may provide power to move along the first rail 112 together. Accordingly, even if the first module 100 does not include a separate motor to move the first front fork bar 122, only the first front powered wheel 123 may control the position of the first module 100 and perform the lifting of the first wheel 20 of the front fork bar 122. That is, it is possible to reduce the manufacturing cost and manufacturing time of the present disclosure by simplifying the first module 100 and reducing the number of parts.

The first front powered wheel 123 may use a known part as long as it can provide a rotational driving force, and there is no limitation in shape. For example, in order to minimize the volume of the first module 100, it may be a wheel receiving a rotational driving force by an in-wheel motor.

As illustrated in FIG. 2, the first front auxiliary wheel 124 is disposed on the side of a direction opposite to the third direction of the first front fork bar 122. In the process of moving the first module 100 by receiving a driving force by the first front powered wheel 123, the first front auxiliary wheel 124 prevents moving from being interrupted as the first front fork bar 122 touches the ground of the parking lot.

The first front auxiliary wheel 124 does not provide a separate rotational driving force. That is, the movement of the first module 100 is controlled only by the first front powered wheel 123 and the second rear powered wheel 233 to be described below. Accordingly, it is possible to minimize the manufacturing cost of the present disclosure by minimizing the expensive parts that provide a rotational driving force.

The first front auxiliary wheel 124 may rotate in the third direction as a rotation axis while the rotation shaft of the wheel is disposed parallel to the ground of the parking lot. Accordingly, the movement of the first front powered wheel 123 is not interrupted.

A plurality of first front auxiliary wheels 124 may be provided. In this case, the plurality of first front auxiliary wheels 124 may be arranged at predetermined intervals along the extending direction of the first front fork bar 122.

Meanwhile, as illustrated in FIG. 1, the first front support member 125 is disposed on one side of the first front fork bar 122 toward the first rear fork bar 132.

As the first front support member 125 moves rearward while the first front fork bar 122 is disposed in the front of the first wheel 20, the first wheel 20 is a roller rotating about a rotational axis extending in the first direction such that the first wheel is easily lifted by the first front fork bar 122 and the first rear fork bar 132.

Accordingly, the first wheel 20 and the first front support member 125 come into contact, and as the first front support member 125 rotates due to the frictional force between the first wheel 20 and the first front support member 125, the first wheel is easily lifted by the first front fork bar 122 and the first rear fork bar 132 to maintain a state spaced apart from the ground of the parking lot.

As illustrated in FIG. 1, the first rear fork 130 is disposed at the rear of the first front fork 120. Accordingly, the first rear fork 130 may be disposed to face the first front fork 120 with the first wheel 20 interposed therebetween.

In this case, as illustrated in FIGS. 1 and 2, the first rear fork 130 of the robot 1 for parking a vehicle according to an exemplary embodiment of the present disclosure also includes a first rear fork body 131, a first rear fork bar 132, a first rear powered wheel 133, a first rear auxiliary wheel 134 and a first rear supporting member 135.

However, the first rear fork body 131, the first rear fork bar 132, the first rear powered wheel 133, the first rear auxiliary wheel 134 and the first rear support member 135 included in the first rear fork 130 respectively correspond to the first front fork body 121, the first front fork bar 122, the first front powered wheel 123, the first front auxiliary wheel 124 and the first front support member 125 included in the first front fork 120, and overlapping parts of the detailed description of the structure or function will be replaced with the description of the first front fork 120, and hereinafter, it will be mainly described that the first rear fork 130 is distinguished from the first front fork 120.

The first rear fork body 131 is disposed at the rear of the first front fork body 121 and is coupled to the first rail 112 to be reciprocally movable in the second direction.

The first rear fork bar 132 extends in a direction opposite to the first direction from the first rear fork body 131. The height in the third direction of the first rear fork bar 132 is formed to be the same as that of the first front fork bar 122.

The first rear fork bar 132 supports the pair of first wheels 20 together with the first front fork bar 122. In this case, the first rear fork bar 132 supports the rear side of the pair of first wheels 20.

The first rear powered wheel 133 is disposed below the first rear fork body 131. The first rear powered wheel 133 is controlled by the controller 600 like the first front powered wheel 123, and provides a rotational driving force for moving the first module 100 together with the first front powered wheel 123.

The first rear powered wheel 133 may also control the movement guided by the first rail 112 of the first rear fork body 131. Accordingly, the first front fork bar 122 is controlled by the first front powered wheel 123 at the front of the first wheel 20, and the first rear fork bar 132 is controlled by the first rear powered wheel 133 at the rear of the first wheel 20 to lift the first wheel 20.

In this case, as illustrated in FIG. 1, the first rear support member 135 is disposed on the front side of the first rear fork bar 132 toward the first front fork bar 122. That is, the first rear support member 135 is disposed to face the first front support member 125.

Accordingly, when the first front fork bar 122 and the first rear fork bar 132 move to be adjacent to each other, as the first wheel 20 comes into contact with the first front support member 125 and the first rear support member 135 and rotates, it is possible to easily separate the first wheel 20 from the ground of the parking lot without vertical movement of the first front fork bar 122 and the first rear fork bar 132.

In this case, while the controller 600 maintains a state in which the rotation shaft of the first wheel 20 is located at the center of the first front fork bar 122 and the first rear fork bar 132, the first front fork bar 122 and the first rear fork bar 132 are moved adjacent to each other.

In order for the controller 600 to maintain a state in which the rotational shaft of the first wheel 20 is located at the center of the first front fork bar 122 and the first rear fork bar 132 as described above, it uses information collected from the wheel recognition sensor 400 to be described below. This will be described in detail below.

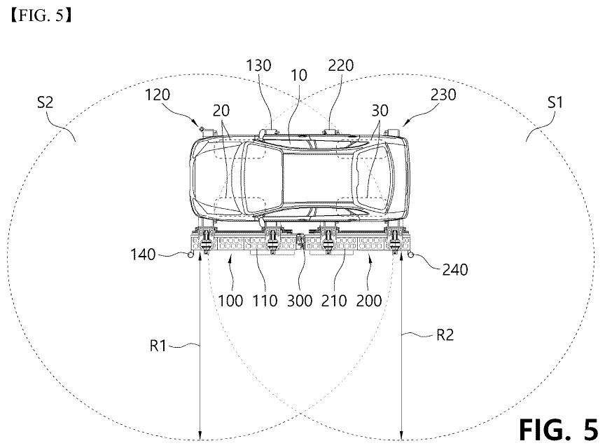

FIG. 5 is a view of the detection areas of a first object recognition sensor and a second object recognition sensor of the robot for parking a vehicle according to an exemplary embodiment of the present disclosure viewed in a direction opposite to the third direction.

As illustrated in FIG. 1, the first object recognition sensor 140 is disposed on a side opposite to the second direction of the first body 110. In this case, in order to widen the area recognized by the first object recognition sensor 140, the first object recognition sensor 140 may be disposed on the uppermost front side of the first body 110.

As illustrated in FIG. 5, the first object recognition sensor 140 collects 3D information on a first area (S1) within a first radius (R1) for the driving of the first module 100 to collect information on obstacles located on the driving path of the first module 100. Accordingly, the controller 600 controls the driving of the first module 100 based on the collected information such that the first module 100 may move while avoiding the obstacles.

In this case, the first object recognition sensor 140 collects information about the surrounding environment in three dimensions. Accordingly, the first object recognition sensor 140 may extract the three-dimensional coordinates of an obstacle based on the first object recognition sensor 140. That is, the first object recognition sensor 140 may collect not only the position of an obstacle, but also the height and shape.

Based on the information collected by the first object recognition sensor 140, the controller 600 determines whether the first module 100 avoids the recognized obstacle or runs over the recognized obstacle. In this case, the first module 100 uses the self-suspension of the vehicle 10 through the connection link 300 to be described below such that the first module 100 may travel along the ground of the parking lot with various sizes of obstacles or severe curvature. This will be described below.

As long as the first object recognition sensor 140 can collect 3D information on the first area (S1) within the first radius (R1), there is no limitation on the type or number of sensors used. For example, a lidar sensor, a radar sensor, an infrared sensor, an ultrasonic sensor and the like may be used. In the present exemplary embodiment, it will be described that one 3D lidar sensor is used.

Meanwhile, as illustrated in FIG. 1, the second module 200 also includes a second object recognition sensor 240 like the first object recognition sensor 140. However, since the second object recognition sensor 240 must be used when the robot 1 for parking a vehicle moves around the second module 200, the second object recognition sensor 240 is disposed above the end of the second module 200 in the second direction, that is, at the rear end thereof, unlike the first object recognition sensor 140.

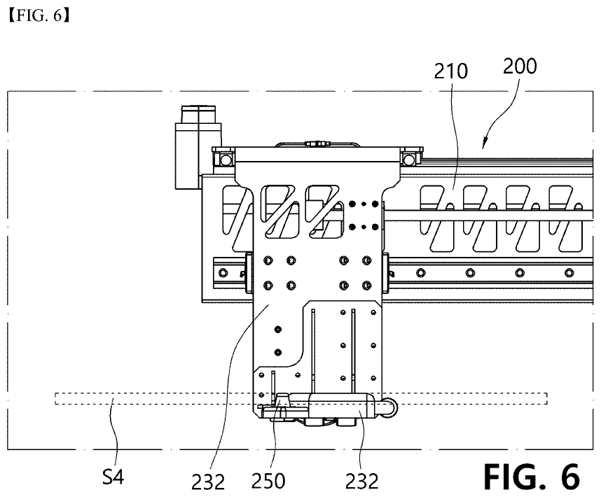

FIG. 6 is a view of the detection areas of a first object recognition auxiliary sensor and a second object recognition auxiliary sensor of the robot for parking a vehicle according to an exemplary embodiment of the present disclosure viewed in a direction opposite to the first direction.

As illustrated in FIG. 2, the first object recognition auxiliary sensor 150 is disposed on the side opposite to the second direction of the first body 110, that is, in the front. The first object recognition auxiliary sensor 150 recognizes an object within a predetermined area.

In this case, the first object recognition auxiliary sensor 150 is a sensor provided to assist the first object recognition sensor 140. To describe this in more detail, even if the first object recognition sensor 140 can collect information in the first area (S1), while the vehicle 10 is lifted on the robot 1 for parking a vehicle by the first module 100 and the second module 200, the first object recognition sensor 140 may not collect information in the shaded area formed by the vehicle 10. In this case, by providing the first object recognition auxiliary sensor 150, it is possible to collect topographic information on the shaded area formed by the vehicle 10.

In this case, the first object recognition auxiliary sensor 150 may be the same sensor as the first object recognition sensor 140 or a different type of sensor. For example, a lidar sensor, a radar sensor, an infrared sensor, an ultrasonic sensor and the like may be used.

However, in the present exemplary embodiment, a 2D lidar sensor is used. Through this, it is possible to maintain the autonomous driving performance of the first module 100 and the second module 200 while lowering the manufacturing cost by using a 2D lidar sensor, which is cheaper than a 3D lidar sensor.

In this case, the first object recognition auxiliary sensor 150 collects information on the two-dimensional area perpendicular to the third direction.

However, when the first object recognition auxiliary sensor 150 is a 2D lidar sensor that collects two-dimensional information, since the purpose of the two-dimensional information collected by the first object recognition auxiliary sensor 150 is to detect an obstacle that interferes with the driving of the first module 100 in advance, the first object recognition auxiliary sensor 150 is disposed adjacent to the ground of the parking lot, as illustrated in FIG. 2.

Meanwhile, as illustrated in FIG. 1, the second module 200 also includes a second object recognition auxiliary sensor 250 like the first object recognition auxiliary sensor 150. However, since the second object recognition auxiliary sensor 250 must be used to assist the second object recognition sensor 240 when the robot 1 for parking a vehicle moves around the second module 200, the second object recognition auxiliary sensor 250 is disposed below the end of the second module 200 in the second direction, that is, at the rear end thereof, unlike the first object recognition auxiliary sensor 150.

More specifically, as illustrated in FIG. 6, it is disposed on the rear side of the front end of the second rear fork bar 232 of the second rear fork 230 of the second module 200. That is, the first object recognition auxiliary sensor 150 and the second object recognition auxiliary sensor 250 are disposed at the outermost diagonal corners of the robot 1 for parking a vehicle, thereby maximizing the detection area.

As illustrated in FIG. 6, when the second object recognition auxiliary sensor 250 moves around the second module 200 by detecting an obstacle in a fourth area (S4) as a two-dimensional area perpendicular to the third direction, it is possible to recognize an obstacle that obstructs the movement of the second body 210 and the second rear fork bar 232 of the second module 200.

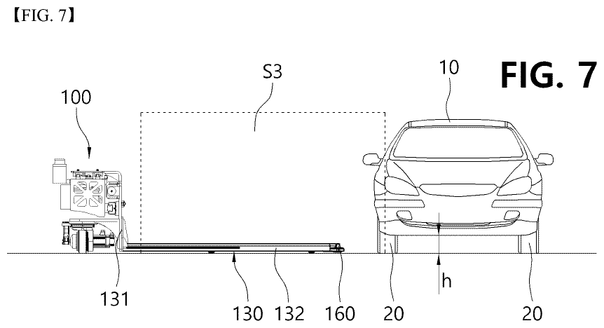

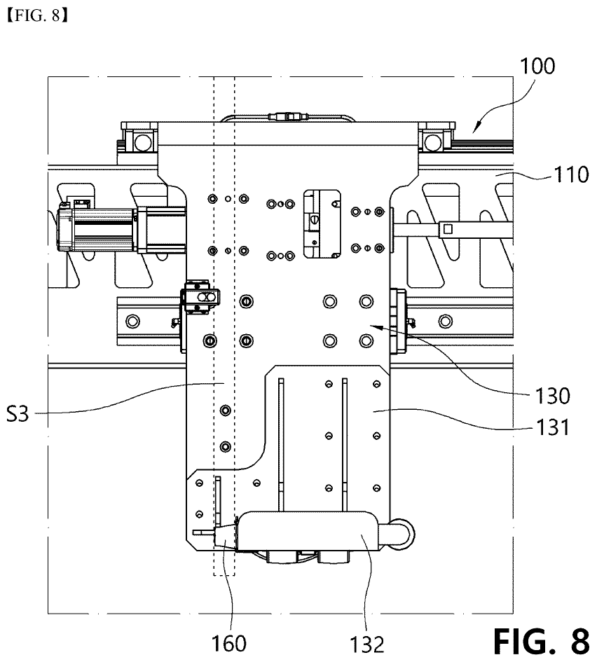

FIG. 7 is a view of the detection area of a first ground height recognition sensor of the robot for parking a vehicle according to an exemplary embodiment of the present disclosure viewed in a direction opposite to the second direction. FIG. 8 is a view of the detection area of a first ground height recognition sensor of the robot for parking a vehicle according to an exemplary embodiment of the present disclosure viewed in a direction opposite to the first direction.

Meanwhile, as illustrated in FIG. 1, the first ground height recognition sensor 160 is disposed at the end of the first rear fork 130 in the second direction, that is, at the rear thereof, to measure the distance between the lower surface of the vehicle 10 and the ground of the parking lot ground. In order to more precisely determine whether the front end of the first rear fork bar 132 can be inserted into the lower side of the vehicle 10, the first ground height recognition sensor 160 is disposed on the front end of the first rear fork bar 132 in the first direction.

As illustrated in FIGS. 7 and 8, the first ground height recognition sensor 160 recognizes an object in a third area (S3) as a two-dimensional area perpendicular to the second direction. If the first ground height recognition sensor 160 can recognize the distance between the lower surface of the vehicle 10 and the ground of the parking lot, that is, the ground height (h), the type of sensor is not limited. In the present exemplary embodiment, a 2D lidar sensor is used as the first ground height recognition sensor 160.

As in the present exemplary embodiment, by using a 2D lidar sensor as the first ground height recognition sensor 160, not only can the ground height (h) of the vehicle 10 be precisely recognized, but also the manufacturing cost of the robot 1 for parking a vehicle can be reduced.

The controller 600 compares the ground height (h) between the lower surface of the vehicle 10 and the ground of the parking lot through the first ground height recognition sensor 160 with the distance from the upper surface of the first rear fork 130 to the ground of the parking lot.

When the ground height (h) is greater than the distance from the upper surface of the first rear fork 130 to the ground of the parking lot, the controller 600 moves the first module 100 in the first direction to insert the first front fork bar 122 and the first rear fork bar 132 into the lower side of the vehicle 10.

Meanwhile, as illustrated in FIG. 2, the second ground height recognition sensor 260 is disposed at the end in a direction opposite to the second direction of the second front fork 220, that is, in the front to measure the distance between the lower surface of the vehicle 10 and the ground of the parking lot. In order to more precisely determine whether the front end of the second front fork bar 222 can be inserted into the lower side of the vehicle 10, the second ground height recognition sensor 260 is disposed on the front end of the second front fork bar 222 in the first direction.

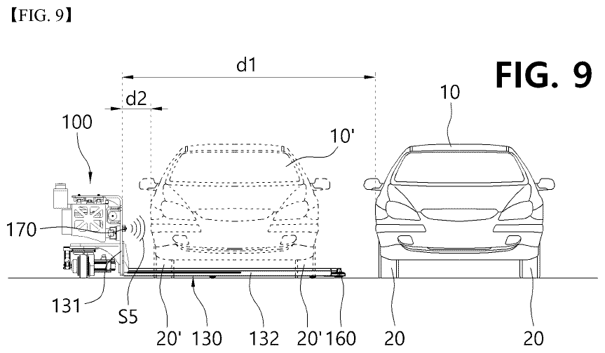

FIG. 9 is a view of the sensing area of a first distance recognition sensor of the robot for parking a vehicle according to an exemplary embodiment of the present disclosure viewed in a direction opposite to the second direction.

As illustrated in FIG. 1, the first distance recognition sensor 170 is disposed on the opposite side of the first direction of the first module 100. In this case, as illustrated in FIG. 9, distances (d1, d2) between the vehicle 10 and the first body 110 of the first module 100 are measured.

To this end, the first distance recognition sensor 170 is disposed on the right side of the first body 110. As illustrated in FIG. 1, in the present exemplary embodiment, it is disposed on the right side of the first rear fork body 131 coupled to the first body 110. However, as long as the first distance recognition sensor 170 can measure the distance between the first body 110 and the left side of the vehicle 10, there is no limitation on the position where the first distance recognition sensor 170 is disposed.

In this case, if the first distance recognition sensor 170 can measure the distance between the first body 110 and the left side of the vehicle 10, the type of sensor is not limited. In the present exemplary embodiment, an ultrasonic sensor is used for the first distance recognition sensor 170 in order to lower the manufacturing cost.

As illustrated in FIG. 9, the controller 600 moves the first module 100 toward the vehicle 10 or separates it from the vehicle 10 through the distance measured by the first distance recognition sensor 170.

When it is described in more detail, as illustrated in FIG. 9, when the distance (d1) from the vehicle 10 recognized by the first distance recognition sensor 170 is greater than the extension length of the first rear fork bar 132, it starts to move to the side of the vehicle 10.

In this case, when the distance (d2) from the vehicle 10′ recognized by the first distance recognition sensor 170 is located within a predetermined distance, the controller 600 stops the movement of the first module 100.

Conversely, this is also applied to the case of departure of the vehicle. That is, when the distance (d2) from the vehicle 10′ recognized by the first distance recognition sensor 170 is shorter than the extension length of the first rear fork bar 132, the controller 600 moves the first module 100 in the opposite direction to the first direction.

In this case, when the distance (d1) from the vehicle 10 recognized by the first distance recognition sensor 170 is longer than the extension length of the first rear fork bar 132, the controller 600 stops the movement of the first module 100, and the first module 100 departs from the vehicle 10 to perform autonomous driving as necessary.

By moving the first module 100 in the first direction until a predetermined distance is reached, a pair of first wheels 20 are disposed between the first front fork bar 122 and the first rear fork bar 132, but the first module 100 is excessively moved in the first direction to prevent the first body 110 from coming into contact with or colliding with the vehicle 10.

Meanwhile, as illustrated in FIG. 1, the second module 200 may also include a second distance recognition sensor 270 like the first distance recognition sensor 170. The second distance recognition sensor 270 is disposed on the right side of the second module 200 and serves the same function as the first distance recognition sensor 170.

However, the first module 100 and the second module 200 are connected by a connection link 300, and while the first module 100 and the second module 200 are arranged side by side when the first module 100 and the second module 200 are coupled by the connection link 300 such that they cannot move relatively in the first direction, the second distance recognition sensor 270 plays an auxiliary role on the first distance recognition sensor 170.

That is, the second distance recognition sensor 270 may be used for determining the truth or falsehood of information recognized through the first distance recognition sensor 170, or may be used as an auxiliary when the first distance recognition sensor 170 fails.

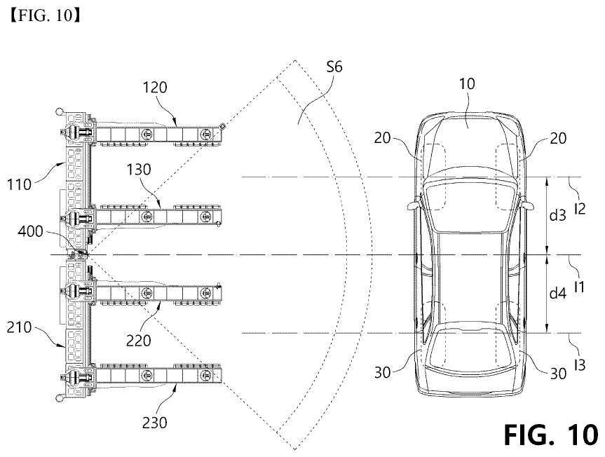

FIG. 10 is a view of the detection area of a wheel recognition sensor the robot for parking a vehicle according to an exemplary embodiment of the present disclosure viewed in a direction opposite to the third direction.

As illustrated in FIGS. 1 and 3, the wheel recognition sensor 400 is disposed between the first module 100 and the second module 200, and is disposed to face a direction in which the first front fork bar 122 protrudes.

The wheel recognition sensor 400 may be fixed to the first body 110 or may be fixed to the second body 210, as in the present exemplary embodiment.

As illustrated in FIG. 10, the wheel recognition sensor 400 collects visual information in a sixth area (S6), and extracts position information of the first wheel 20 and the second wheel 30 from the collected visual information.

To describe this in more detail, the wheel recognition sensor 400 is a type of camera, which collects image information by photographing the left side of the vehicle 10, and differentiates the first wheel 20 and the second wheel 30 from the collected image information to determine the distance between the first wheel 20 and the second wheel 30 of a vehicle 10 to be parked.

In this case, the controller 600 controls the positions of the first module 100 and the second module 200 such that the midpoint between the first module 100 and the second module 200 is arranged to be placed side by side with the midpoint between the first wheel 20 and the second wheel 30 and the first direction through the information collected from the wheel recognition sensor 400. That is, the first module 100 and the second module 200 are controlled such that the distance (d3) from the rotation axis (I2) of the first wheel 20 to the imaginary line (I1) extending from the midpoint between the first module 100 and the second module 200 in the first direction is identical to the distance (d4) from the rotation axis (I3) of the second wheel 30 to the imaginary line (I1) extending from the midpoint between the first module 100 and the second module 200 in the first direction.

In this case, the controller 600 controls the positions of the first front fork bar 122 and the first rear fork bar 122 such that the rotation shaft of the first wheel 20 is disposed between the first front fork bar 122 and the first rear fork bar 132.

In addition, before inserting the first front fork bar 122 and the first rear fork bar 132 into the lower part of the vehicle 10 based on the information measured through the wheel recognition sensor 400, the controller 600 adjusts the distance between the first front fork bar 122 and the first rear fork bar 132 to be wider than the diameter of the first wheel 20.

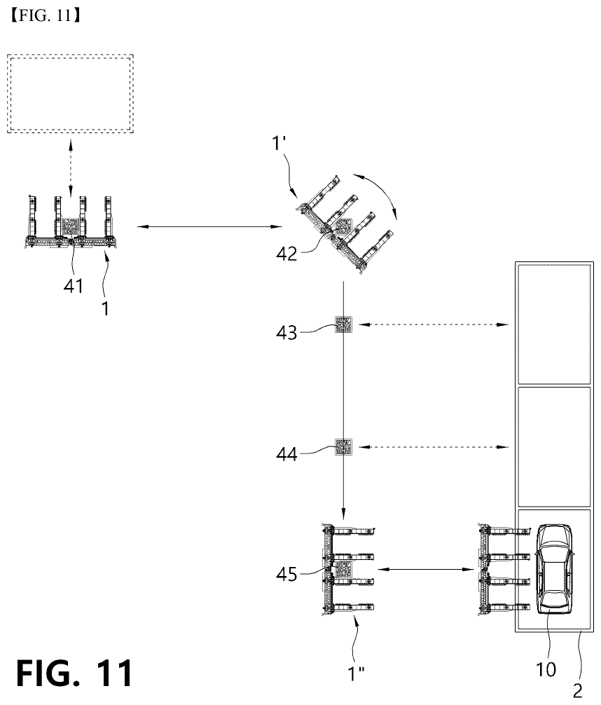

FIG. 11 is a diagram illustrating a process in which the robot for parking a vehicle according to an exemplary embodiment of the present disclosure recognizes a marker and moves.

The robot 1 for parking a vehicle according to an exemplary embodiment of the present disclosure performs autonomous driving by the controller 600 based on the information collected by the first object recognition sensor 140, the second object recognition sensor 240, the first object recognition auxiliary sensor 150 and the second object recognition auxiliary sensor 250 as described above.

In this case, since an expensive vehicle 10 is parked without the driver, the accuracy of autonomous driving of the robot 1 for parking a vehicle must be ensured. To this end, as illustrated in FIG. 3, the robot 1 for parking a vehicle according to an exemplary embodiment of the present disclosure may further include a marker sensor 500 for recognizing a marker.

The marker sensor 500 may recognize a separately provided marker to confirm location information. In this case, the marker is displayed on the ground of the parking lot where the present disclosure is to be used. Accordingly, the marker sensor 500 is disposed to face downward in order to recognize the marker.

The marker sensor 500 may be a different sensor depending on the type of marker. For example, in the case of a marker that reflects a specific light, it may be an optical sensor that detects the corresponding light, or a camera capable of recognizing a QR code as in the present exemplary embodiment.

The marker includes location information for a specific location of the parking lot. Accordingly, as the marker sensor 500 recognizes a specific marker, the controller 600 may accurately determine the position information of the robot 1 for parking a vehicle.

In this case, since the location information is collected through the marker, the marker sensor 500 is disposed between the first module 100 and the second module 200, which are the central positions of the robot 1 for parking a vehicle.

The controller 600 increases the accuracy of autonomous driving by comparing the location information collected by the first object recognition sensor 140, the second object recognition sensor 240, the first object recognition auxiliary sensor 150 and the second object recognition auxiliary sensor 250 with the location information of the marker recognized by the marker sensor 500 to correct the location information collected by the first object recognition sensor 140, the second object recognition sensor 240, the first object recognition auxiliary sensor 150 and the second object recognition auxiliary sensor 250.

As illustrated in FIGS. 1 and 2, the second module 200 of the robot 1 for parking a vehicle according to an exemplary embodiment of the present disclosure includes a second body 210, a second front fork 220, and a second rear fork 230, a second object recognition sensor 240, a second object recognition auxiliary sensor 250, a second ground height recognition sensor 260 and a second distance recognition sensor 270. In this case, the description of each configuration of the second module 200 will be replaced with the description of the first body 110, the first front fork 120, the first rear fork 130, the first object recognition sensor 140, the first object recognition auxiliary sensor 150, the first ground height recognition sensor 160 and the first distance recognition sensor 170 of the first module 100, except for the above-described contents. Similarly, the detailed description of the second front fork 220 and the second rear fork 230 will also be replaced with the description of the first front fork 120 and the first rear fork 130, except for the above-described contents.

Hereinafter, the process in which the robot 1 for parking a vehicle according to an exemplary embodiment of the present disclosure parks the vehicle 10 will be described with reference to FIG. 11.

The controller 600 moves the robot 1 for parking a vehicle to the left of the vehicle 10 to be parked. In this process, the controller 600 analyzes the information obtained by using the first object recognition sensor 140 and the second object recognition sensor 240 to move the robot 1 for parking a vehicle.

In this case, the controller 600 recognizes a marker 41 disposed in the moving process through the marker sensor 500 and verifies the position of the robot 1 for parking a vehicle, and if there is an error in the position, it moves by modifying the location information to the location of the marker 41 (refer to FIG. 11).

While the robot 1 for parking a vehicle is located on the left side of the vehicle 10, the controller 600 moves the robot 1 for parking a vehicle such that the midpoint between the first module 100 and the second module 200 corresponds to the midpoint between the first wheel 20 and the second wheel 30 based on the information collected by the wheel recognition sensor 400.

The controller 600 checks the ground height (h) of the vehicle through the first ground height recognition sensor 160, and when the distance from the upper surface of the first rear fork bar 132 to the ground of the parking lot is smaller than the ground height (h), the robot 1 for parking a vehicle starts to be inserted into the lower part of the vehicle 10 (refer to FIG. 7).

In this case, the controller 600 checks the distance between the first body 110 and the vehicle 10 through the first distance recognition sensor 170, and if the distance between the first body 110 and the vehicle reaches a predetermined distance (d2), it stops the movement of the robot 1 for parking a vehicle (refer to FIG. 9).

The controller 600 moves the first front fork bar 122 and the first rear fork bar 132 to be adjacent to each other, and by moving the second front fork bar 222 and the second rear fork bar 232 to be adjacent to each other, the vehicle is lifted by the robot 1 for parking a vehicle.

While the vehicle 10 is lifted on the robot 1 for parking a vehicle, the controller 600 analyzes information obtained by using the first object recognition sensor 140 and the second object recognition sensor 240 to move the robot 1 for parking a vehicle to the parking space.

In this case, the controller 600 increases the accuracy of autonomous driving by analyzing the information on the shaded area formed by the vehicle 10 with the information obtained by using the first object recognition auxiliary sensor 150 and the second object recognition auxiliary sensor 250.

Also in this case, as described above, the position information is corrected by using the marker sensor 500. Particularly, in order to efficiently operate a parking space, when a position at which the robot 1 for parking a vehicle changes the moving direction is designated, the controller 600 may move the robot 1 for parking a vehicle through autonomous driving until the marker sensor 500 recognizes the marker 42 indicating the corresponding position.

In addition, the markers 43, 44, 45 may be disposed at positions corresponding to specific parking spaces, and the controller 600 may move the vehicle 10 accurately to the destination by continuously correcting the location information through the marker sensor 500 while avoiding obstacles through autonomous driving. (refer to FIG. 11).

However, the marker only serves to assist autonomous driving, and in principle, the controller 600 may perform autonomous driving only with information collected from the first object recognition sensor 140 and the second object recognition sensor 240.

While the vehicle 10 is located in a specific parking space, the controller 600 separates the first front fork bar 122 and the first rear fork bar 132 apart, and separates the second front fork bar 222 and the second rear fork bar 232 apart so as to place the vehicle 10 down in a specific parking space.

While the preferred exemplary embodiments according to the present disclosure have been described above, it is apparent to those skilled in the art that in addition to the aforementioned exemplary embodiments, the present disclosure may be implemented as other specific forms without departing from the purpose and the scope of the present disclosure. Accordingly, the aforementioned exemplary embodiments should be only illustrative and not restrictive, and thus, the present disclosure is not limited to the aforementioned description, but may be modified within the scope of the appended claims and equivalents thereto.

1. A robot for parking a vehicle, which lifts a vehicle having a pair of first wheels and a pair of second wheels to park in a parking lot, the robot comprising:
a first module for lifting the pair of first wheels by moving to the side of a first direction as a direction in which the rotation shafts of the pair of first wheels of the vehicle extend;
a second module which is disposed on the side of a second direction as a direction from the pair of first wheels of the first module toward the pair of second wheels and lifts the pair of second wheels by moving toward the side of the first direction of the pair of second wheels of the vehicle;
a connection link for connecting the first module and the second module; and
a controller for controlling the first module and the second module.

2. The robot of claim 1, wherein the connection link is formed such that the first module is pivotally rotatable about a rotational axis extending in the first direction relative to the second module.

3. The robot of claim 1, wherein the connection link is formed such that the first module is reciprocally movable in a third direction perpendicular to the first direction and the second direction relative to the second module.

4. The robot of claim 1, wherein the first module comprises:
a first body extending in the second direction; and
a first front fork and a first rear fork coupled to the first body and supporting the pair of first wheels, and
wherein the second module comprises:
a second body extending in the second direction; and
a second front fork and a second rear fork coupled to the second body and supporting the pair of second wheels.

5. The robot of claim 4, wherein the first body comprises a first rail extending in the second direction,
wherein the first front fork comprises a first front fork body coupled to the first rail so as to be reciprocally movable in the second direction, and a first front fork bar extending from the first front fork body in the first direction and supporting one side of the pair of first wheels, and
wherein the first rear fork comprises a first rear fork body coupled to the first rail so as to be reciprocally movable in the second direction, and a first rear fork bar extending from the first rear fork body in the first direction and supporting the other side of the pair of first wheels.

6. The robot of claim 5, wherein the first front fork further comprises:
a first front powered wheel disposed on a side opposite to a third direction perpendicular to the first direction and the second direction of the first front fork body to provide a driving force; and
a first rear powered wheel disposed on a side opposite to the third direction of the first rear fork body to provide a driving force.

7. The robot of claim 6, wherein the first front fork further comprises:
at least one first front auxiliary wheel disposed on a side opposite to the third direction of the first front fork bar; and
at least one first rear auxiliary wheel disposed on a side opposite to the third direction of the first rear fork bar.

8. The robot of claim 5, wherein the first front fork further comprises a first front support member disposed on one side of the first front fork bar toward the first rear fork bar, and
wherein the first rear fork further comprises a first rear support member disposed on one side of the first rear fork bar toward the first front fork bar.

9. The robot of claim 8, wherein the controller places the pair of first wheels between the first front support member and the first rear support member such that the pair of first wheels are spaced apart from a ground of the parking lot, and moves the first front support member and the first rear support member to be adjacent to each other.

10. The robot of claim 4, further comprising:
a first object recognition sensor disposed on a side opposite to the second direction of the first body to recognize an object in three dimensions within a predetermined area; and
a second object recognition sensor disposed on a side of the second direction of the second body to recognize an object in three dimensions within a predetermined area.

11. The robot of claim 10, wherein the controller analyzes information collected by the first object recognition sensor and the second object recognition sensor to drive the first module and the second module.

12. The robot of claim 11, further comprising:
a first object recognition auxiliary sensor disposed on a side opposite to the second direction of the first body to recognize an object in two dimensions within a predetermined area perpendicular to a third direction perpendicular to the first direction and the second direction; and
a second object recognition auxiliary sensor disposed at an end of the second direction in the second rear fork to recognize an object in two dimensions within a predetermined area perpendicular to the third direction,
wherein the controller further analyzes information collected by the first object recognition auxiliary sensor and the second object recognition auxiliary sensor to drive the first module and the second module.

13. The robot of claim 10, further comprising:
a marker sensor disposed between the first body and the second body to recognize a marker.

14. The robot of claim 13, wherein the controller compares location information collected by the first object recognition sensor and the second object recognition sensor with location information of a marker recognized by the marker sensor to correct location information collected by the first object recognition sensor and the second object recognition sensor.

15. The robot of claim 4, further comprising:
a first ground height recognition sensor disposed at an end of the second direction of the first rear fork to recognize an object in two dimensions within a predetermined area perpendicular to the second direction.

16. The robot of claim 15, wherein when the distance between the lower surface of the vehicle and the ground of the parking lot through the first ground height recognition sensor is greater than the distance from the upper surface of the first rear fork to the ground of the parking lot, the controller moves the first module and the second module in the first direction such that the first front fork and the first rear fork support the first wheel and the second front fork and the second rear fork support the second wheel.

17. The robot of claim 15, wherein the first module further comprises a first distance recognition sensor disposed on the side of the first direction to measure a distance between the vehicle and the first module.

18. The robot of claim 17, wherein the controller moves the first module and the second module in the first direction until the distance measured by the first distance recognition sensor becomes a predetermined distance.

19. The robot of claim 1, further comprising:
a wheel recognition sensor disposed between the first module and the second module to recognize the first wheel and the second wheel of the vehicle.

20. The robot of claim 1, wherein the controller moves the first module and the second module such that a midpoint between the first module and the second module is arranged side by side with a midpoint between the first wheel and the second wheel along the first direction.
